(19) United States
(12) Patent Application Publication
(10) Pub. No.: US 2020/0369078 A1
(43) Pub. Date: Nov. 26, 2020

(54) WHEEL COVER MOUNTING ASSEMBLY

(71) Applicant: SOUN MIIN CO., LTD., Tainan City (TW)

(72) Inventor: YUNG-TING HSIEH, TAINAN CITY (TW)

(21) Appl. No.: 16/416,469

(22) Filed: May 20, 2019

(51) Int. Cl. B60B 7/10; B60B 31/06; B60B 7/08

(52) U.S. Cl. CPC B60B 7/10; B60B 2900/212; B60B 7/08; B60B 31/06

(57) ABSTRACT

A wheel cover mounting assembly is revealed. A cover whose shape is similar to that of an automotive wheel is mounted into an axle hole of the automotive wheel by a mounting assembly. The mounting assembly includes a through hole at the center of the wheel cover and a circular wall arranged in the through hole. A threaded segment formed on an inner surface of the circular wall and a moveable base are threaded and locked with each other. A thread portion engaged with the threaded segment is disposed on surface of the moveable base. Through the design of the relative thread depth of the thread portion with regard to the threaded segment, the moveable base presses the circular wall against the axle hole of the automotive wheel for positioning the circular wall in the axle hole firmly.

### BACKGROUND OF THE INVENTION

### Field of the Invention

The present invention relates to a wheel cover mounting assembly, especially to a wheel cover mounting assembly that is used for convenient adjustment of packing positioning in axle holes of automotive wheels.

### Description of Related Art

There are two main types of automobile wheels-steel wheel and aluminum alloy wheels. Generally a wheel cover is placed upon the automobile wheel for decoration and protection. After being treated by processes such as coating and anodizing, the aluminum alloy wheel with ribs and through holes already has beautiful appearance and the wheel cover is no more needed. However, while driving on the road, objects on the road such as stones, iron pieces may be kicked up by the tires and then hit the aluminum alloy wheel to cause damages such as scratches, dents, etc. on a surface of the aluminum alloy wheel. Moreover, the objects are attached to the aluminum alloy wheel to cause stains difficult to be cleaned. The appearance of the aluminum alloy wheel is affected. Thereby the aluminum alloy wheel is provided with the wheel cover for protection. For people who like car modification, they will mount a molded plastic wheel cover with a polished surface/or matte plating on the aluminum alloy wheel in order to have stylish appearance and unique value.

Although the attachment of the wheel cover is not prohibited by domestic laws, the essential safety requirement is that the wheel cover should be held firmly in place in a moving car, without falling off. Thus a plurality of techniques related to the assembly of the wheel cover has already been developed and applied patents such as “wheel cover assembly” revealed in Taiwanese Pat. Pub. No. M280307, “wheel cover of aluminum alloy wheel” revealed in Taiwanese Pat. Pub. No. 547351, and “wheel cover of aluminum alloy wheel” revealed in Taiwanese Pat. Pub. M275112. However, there is a size/position difference between the aluminum alloy wheels of the same brand because they are made by different manufacturers. Thus the problems such as the edge of the hole of the wheel cover is unable to be mounted into or firmly locked in the corresponding hole of the aluminum alloy wheel may occur. Thus the wheel cover is unable to be placed on the aluminum alloy wheel produced by different manufacturers. This cause lots of trouble in design and development of the wheel cover.

In order to solve the problem, a wheel trim is disclosed in Taiwanese Pat. Pub. No. M522868. The wheel trim with a central hole features on that a mounting base integrally formed on the inner side of the central hole and a circular portion extended from the inner side of the mounting base. A plurality of notches is formed on the circular portion and an elastic piece is formed between the two adjacent notches. An adjustment block used in combination with the wheel trim includes a small end with a smaller diameter and a large end with a larger diameter. The adjustment block is mounted into the circular portion by means of the small end thereof. A screw is horizontally inserted through the mounting base to be threaded to the adjustment block. While threaded the screw, the large end of the adjustment block is moved toward the inside of the circular portion and the respective elastic piece is also forced to extend outward.

Although the above prior art has overcome certain shortcomings, there are still some problems existed. The regulation block is solid so that the end surface thereof at the end with larger diameter may occasionally abut against the axle of the car of certain brands. This results in the release of the automobile wheel cover while driving.

Thus there is room for improvement and there is a need to provide a novel wheel cover mounting assembly with higher practical value.

### SUMMARY OF THE INVENTION

Therefore it is a primary object of the present invention to provide a wheel cover mounting assembly that is used for convenient adjustment of packing positioning in axle holes of automotive wheels.

In order to achieve the above object, a wheel cover mounting assembly according to the present invention is used for connecting a wheel cover to an axle hole of an automotive wheel and composed of a wheel cover and a moveable base. A circular wall is arranged around a central through hole of the wheel cover while a threaded segment formed on an inner surface of the circular wall is threaded and locked on the moveable base. A thread portion engaged with the threaded segment is disposed on an outer surface of the moveable base. Through the design of the relative thread depth of the thread portion with regard to the threaded segment, the moveable base presses the circular wall against the axle hole of the automotive wheel for positioning the circular wall in the axle hole stably.

The thread depth (distance between the crest and the root of the thread) of the respective thread on the thread portion is decreased in turn so that the threads on the thread portion engage with and press supporting ribs of the circular wall against the axle hole of the automotive wheel. Thus the supporting ribs are extended outward to be locked in the axle hole of the automotive wheel.

The thread depth (distance between the crest and the root of the thread) of the respective thread on the thread portion is decreased in turn from a first end to a second end of the moveable base.

The thread depth (distance between the crest and the root of the thread) of the respective thread on the thread portion is decreased in turn from the second end to the first end of the moveable base.

The thread depth of the respective thread on the inner side of the circular wall is increased in turn from the end with the through hole to the end with the supporting rib while the thread depth of the thread portion of the moveable base is fixed.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of a first embodiment according to the present invention;

FIG. 2 is another explosive view of the first embodiment according to the present invention;

FIG. 3 is a perspective view of the first embodiment according to the present invention;

FIG. 4 is a partial exploded sectional view of the first embodiment according to the present invention;

FIG. 5 is a partial enlarged view of the first embodiment in FIG. 4 according to the present invention;

FIG. 6 is an assembled sectional view of the first embodiment according to the present invention;

FIG. 7 is a partial enlarged sectional view of a second embodiment according to the present invention;

FIG. 8 is a partial enlarged sectional view of a third embodiment according to the present invention.

### DETAILED DESCRIPTION OF THE PREFERRED EMBODIMENT

In order to learn technical features and functions of the present invention more clearly, please refer to the following embodiments with detailed descriptions, related figures and reference numbers.

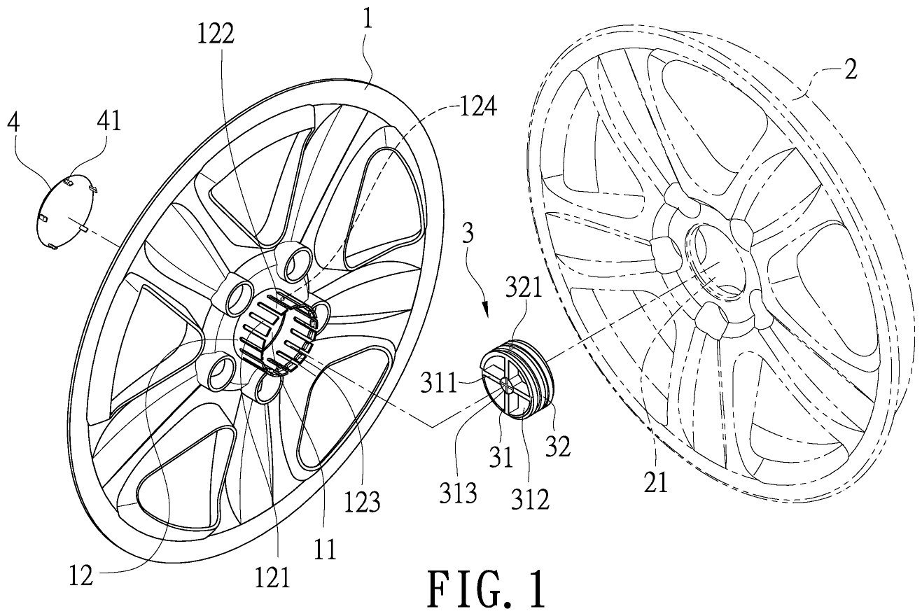

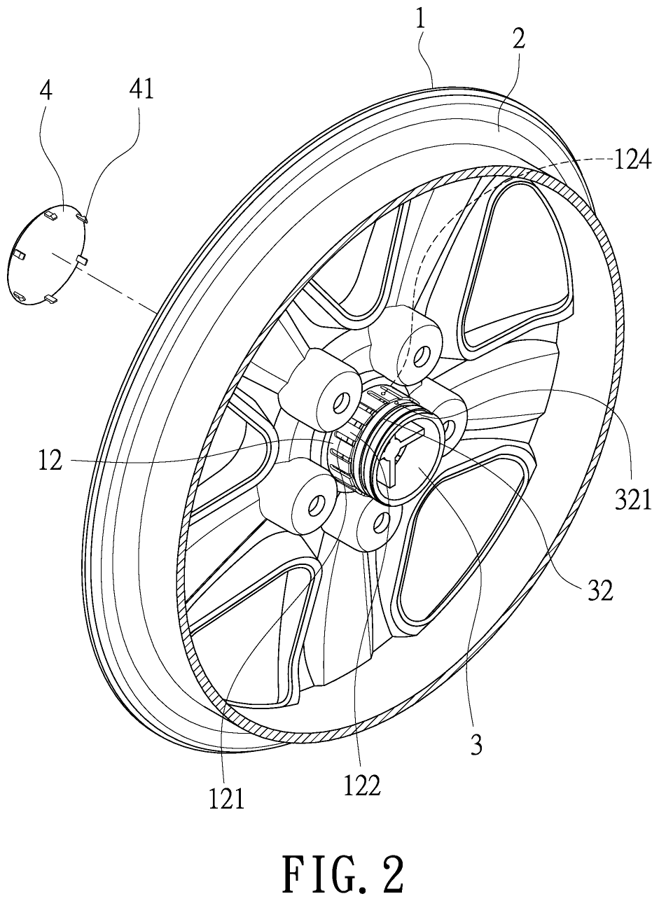

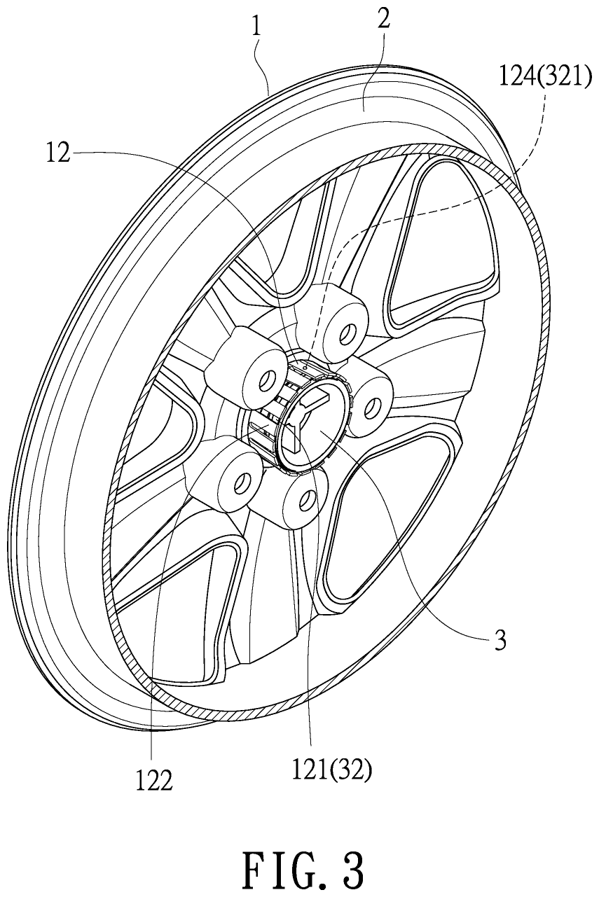

Refer to FIG. 1, FIG. 2 and FIG. 3, a wheel cover mounting assembly according to the present invention includes a wheel cover 1, a moveable base 3 and an outer cover 4. The wheel cover 1 is placed over an automotive wheel 2 on which the tire is mounted. The wheel cover 1 consists of a through hole 11 arranged at the center of the wheel cover 1 and a circular wall 12 extended from the circumference of the through hole 11 to the inner side thereof. The circular wall 12 is mounted into an axle hole 21 on the center of the automotive wheel 2 correspondingly. A plurality of grooves 121 is circularly disposed on the circular wall 12, extending from one end of the circular wall 12 toward the through hole 11 and a supporting rib 122 is formed between the two adjacent grooves 121. A threaded segment 123 is arranged at an inner surface of each of the supporting ribs 122. A limiting member 124 is disposed on the circular wall 12.

The moveable base 3 has a first end whose surface is provided with an action portion 31 used for driving the moveable base 3 to rotate and a second end that is hollow. A thread portion 32 able to engage with the threaded segment 123 is disposed on an outer surface of the moveable base 3. The thread depth (defined as the distance between the crest and the root of the thread) of threads on the thread portion 32 is decreased in turn. Thus the threads on the thread portion 32 engage with and press the supporting ribs 122 against the axle hole 21 of the automotive wheel 2. Thereby the supporting ribs 122 are extended outward and locked in the axle hole 21 of the automotive wheel 2. A positioning member 321 is disposed on the thread portion 32 at the position corresponding to the limiting member 124.

The outer cover 4 is mounted on the central through hole 11 of the wheel cover 1 and is provided with a plurality of locking pins 41 that is locked with and positioned by the grooves 121 respectively.

As shown in FIG. 1-6, in order to place the wheel cover 1 on the automotive wheel 2, first get a wheel cover 1 whose shape is similar to that of the automotive wheel 2 and detach the outer cover 4 originally placed on the axle hole 21 of the automotive wheel 2. Then the wheel cover 1 is placed into the axle hole 21 of the automotive wheel 2 by a mounting assembly. While in use, the mounting assembly of the present invention has a plurality of embodiments illustrated in details as follows.

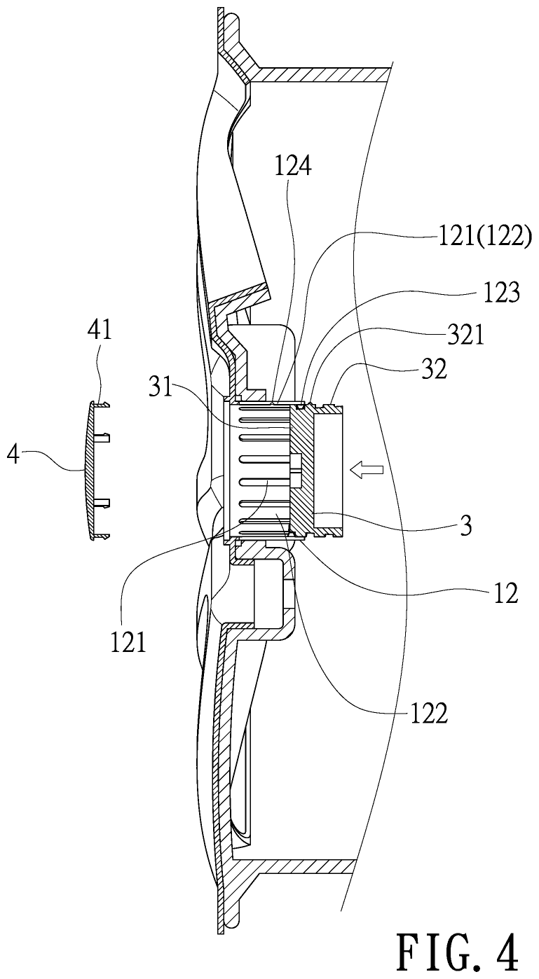

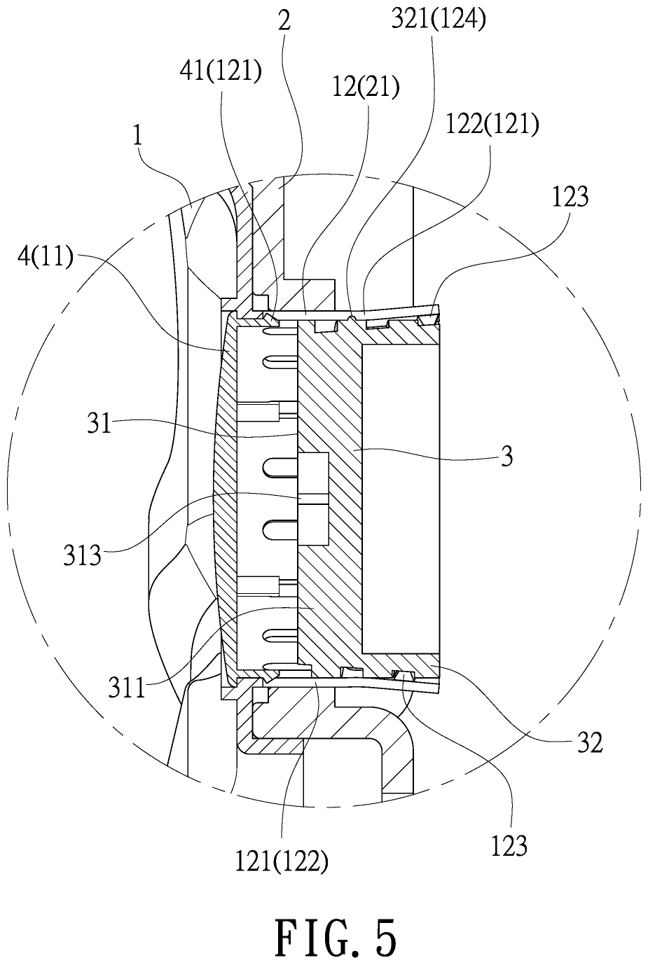

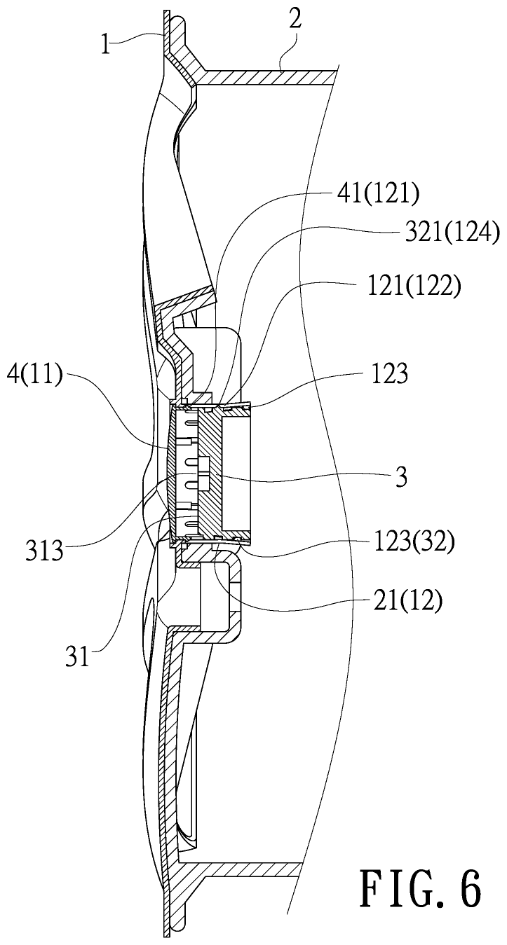

Refer to FIG. 4, FIG. 5 and FIG. 6, the distance between the crest and the root of the respective thread on the thread portion 32 is decreased in turn along the direction from the first end to the second end of the moveable base 3. While in use, the first end of the moveable base 3 is aligned with and threaded into an opening of the circular wall 12 of the wheel cover 1 by the threaded segment 123 on the inner surface of the supporting rib 122 of the circular wall 12. When the threaded segment 123 is just in contact with the thread portion 32 of the moveable base 3, the threaded segment 123 is threaded and mounted easily because the thread on the first end of the thread portion 32 has the larger distance between the crest and the root. At the moment, the supporting rib 122 of the circular wall 12 has not been extended yet. Then the wheel cover 1 is placed over the automotive wheel 2 and the circular wall 12 is mounted into the axle hole 21. Next the thread portion 32 is rotated with respect to the threaded segment 123 by rotating the action portion 31 of the moveable base 3 so that the moveable base 3 is threaded out along the direction toward the through hole 11. By the threads with decreasing thread depth on the thread portion 32, the supporting rib 122 of the circular wall 12 is pushed to extend outward and press against the axle hole 21 of the automotive wheel 2. When the positioning member 321 is locked and mounted in the limiting member 124, the supporting rib 122 reaches the maximum extension for positioning the wheel cover 1. Lastly the outer cover 4 originally detached from the axle hole 21 of the automotive wheel 2 is mounted into the central through hole 11 of the wheel cover 1 firmly by the locking pins 41 and the grooves 121 locked with and positioned by each other.

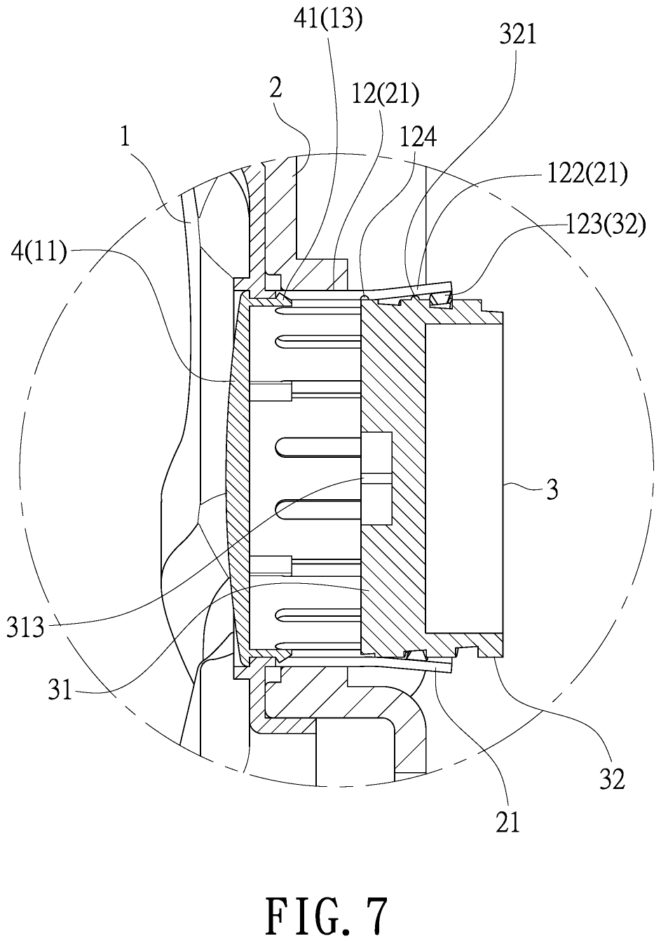

Refer to FIG. 7, another embodiment is revealed. In this embodiment, the distance between the crest and the root of the respective thread on the thread portion 32 is decreased in turn along the direction from the second end to the first end of the moveable base 3. While in use, the second end of the moveable base 3 is aligned with and threaded into the central hole 11 of the wheel cover 1 by the threaded segment 123 on the inner surface of the supporting rib 122 of the circular wall 12. When the threaded segment 123 is just in contact with the thread portion 32 of the moveable base 3, the threaded segment 123 is threaded and mounted easily because the thread on the second end of the thread portion 32 has a larger distance between the crest and the root of the thread. At the moment, the supporting rib 122 of the circular wall 12 has not been extended yet. Then the circular wall 12 of the wheel cover 1 is mounted into the axle hole 21 of the automotive wheel 2. Next the thread portion 32 of the member moveable base 3 is rotated with respect to the threaded segment 123 by rotating the action portion 31 of the moveable base 3 so that the moveable base 3 is threaded into the axle hole 21. By the threads with decreasing thread depth on the thread portion 32, the supporting rib 122 of the circular wall 12 is pushed to extend outward and press against the axle hole 21 of the automotive wheel 2. When the positioning member 321 is locked and mounted in the limiting 124, the supporting rib 122 reaches the maximum extension for positioning the wheel cover 1. Lastly the outer cover 4 originally detached from the axle hole 21 of the automotive wheel 2 is mounted into the central through hole 11 of the wheel cover 1 firmly by the locking pins 41 and the grooves 121 locked with and positioned by each other.

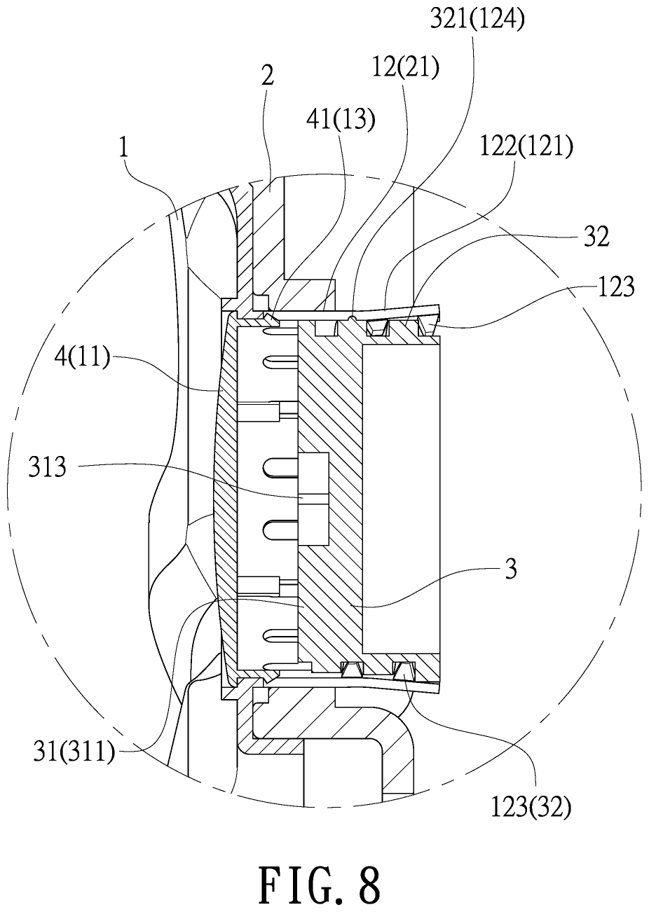

Refer to FIG. 8, a further embodiment is disclosed. In this embodiment, the thread depth of the respective thread of the threaded segment 123 on the inner side of the circular wall 12 is increased in turn from the end with the through hole 11 to the end with the supporting rib 122 while the thread depth of the thread portion 32 of the moveable base 3 is fixed. In practice, the second end of the moveable base 3 is aligned with and threaded into the central hole 11 of the wheel cover 1 by the threaded segment 123 on the inner surface of the supporting rib 122 of the circular wall 12. When the thread portion 32 of the moveable base 3 is just in contact with the threaded segment 123, the threaded segment 123 is mounted and threaded easily because the thread on that end has a lower depth. At the moment, the supporting rib 122 of the circular wall 12 has not been extended yet. Later the circular wall 12 of the wheel cover 1 is mounted into the axle hole 21 of the automotive wheel 2. Then the thread portion 32 of the moveable base 3 is rotated with respect to the threaded segment 123 by rotating the action portion 31 of the moveable base 3 so that the moveable base 3 is threaded into the axle hole 21. By the threads with larger thread depth on the threaded segment 123 in contact with and being pushed by the thread portion 32, the supporting rib 122 is pushed to extend outward and press against the axle hole 21 of the automotive wheel 2 for positioning the wheel cover 1. Lastly the outer cover 4 originally detached from the axle hole 21 of the automotive wheel 2 is mounted into the central through hole 11 of the wheel cover 1 firmly by the locking pins 41 and the grooves 121 locked with and positioned by each other.

Furthermore, as shown in FIG. 1, the action portion 31 of the moveable base 3 is composed of at least one rib 311, at least one space 312 and at least one tool slot 313. The rib 311 is disposed on the action portion 31 and connected to the wall surface of the moveable base 3 while the space 312 is formed between the rib 311 and the wall surface. The user can move his hand into the space 312 for holding the rib 311 to rotate the moveable base 3. The tool slot 313 is arranged at a surface on one end of the rib 311. The moveable base 3 is rotated by a tool mounted in the tool slot 313 and turning the rib 311.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A wheel cover mounting assembly comprising:
a wheel cover that is placed over an automotive wheel and having a central through hole, and
a circular wall disposed around an inner end of the through hole for being mounted into an axle hole on the center of the automotive wheel and composed of a plurality of grooves circularly disposed on the circular wall and extending from one end of the circular wall toward the through hole, a plurality of supporting ribs each of which is formed between the two adjacent grooves, and a threaded segment arranged at an inner surface of the supporting rib and provided with threads having fixed thread depth;
a moveable base that includes an action portion disposed on a surface of a first end for driving the moveable base to rotate, a second end that is hollow, and a thread portion disposed on an outer surface of the moveable base and engaged with the threaded segment; and
an outer cover that is mounted on the central through hole of the wheel cover and provided with a plurality of locking pins locked with and positioned by the grooves respectively;
wherein the distance between the crest and the root of threads on the thread portion is decreased in turn so that the threads on the thread portion engage with and press the supporting ribs against the axle hole of the automotive wheel; thus the supporting ribs are extended outward and locked in the axle hole of the automotive wheel.

2. The assembly as claimed in claim 1, wherein the distance between the crest and the root of the threads on the thread portion is decreased in turn from the first end to the second end of the moveable base.

3. The assembly as claimed in claim 1, wherein the distance between the crest and the root of the threads on the thread portion is decreased in turn from the second end to the first end of the moveable base.

4. The assembly as claimed in claim 1, wherein a limiting member is disposed on the circular wall of the wheel cover while a positioning member is disposed on the thread portion of the moveable base and corresponding to the limiting member; the positioning member and the limiting member are locked with and positioned by each other.

5. The assembly as claimed in claim 1, wherein the action portion of the moveable base includes at least one rib connected to the wall surface of the moveable base and a space formed between the rib and the wall surface for allowing the holding of the rib to rotate the movable base.

6. The assembly as claimed in claim 2, wherein the action portion of the moveable base includes at least one rib connected to the wall surface of the moveable base and a space formed between the rib and the wall surface for allowing the holding of the rib to rotate the movable base.

7. The assembly as claimed in claim 3, wherein the action portion of the moveable base includes at least one rib connected to the wall surface of the moveable base and a space formed between the rib and the wall surface for allowing the holding of the rib to rotate the movable base.

8. The assembly as claimed in claim 5, wherein at least one tool slot is arranged at a surface on one end of the rib.

9. The assembly as claimed in claim 6, wherein at least one tool slot is arranged at a surface on one end of the rib.

10. The assembly as claimed in claim 7, wherein at least one tool slot is arranged at a surface on one end of the rib.

11. A wheel cover mounting assembly comprising:
a wheel cover that is placed over an automotive wheel and having a central through hole, and
a circular wall disposed around an inner end of the through hole for being mounted into an axle hole on the center of the automotive wheel and composed of a plurality of grooves circularly disposed on the circular wall and extending from one end of the circular wall toward the through hole, a plurality of supporting ribs each of which is formed between the two adjacent grooves, and a threaded segment arranged at an inner surface of the supporting rib and provided with threads having thread depth increased in turn from the end with the through hole to the end with the supporting rib;
a moveable base that includes an action portion disposed on a surface of a first end for driving the moveable base to rotate, a second end that is hollow, and a thread portion disposed on an outer surface of the moveable base and engaged with the threaded segment; and
an outer cover that is mounted on the central through hole of the wheel cover and provided with a plurality of locking pins locked with and positioned by the grooves respectively;
wherein the distance between the crest and the root of each of threads on the thread portion is the same and the threads on the thread portion are able to engage with and press the supporting ribs against the axle hole of the automotive wheel so that the supporting ribs are extended outward and locked in the axle hole of the automotive wheel.

12. The assembly as claimed in claim 11, wherein a limiting member is disposed on the circular wall of the wheel cover while a positioning member is disposed on the thread portion of the moveable base and corresponding to the limiting member; the positioning member and the limiting member are locked with and positioned by each other.

13. The assembly as claimed in claim 11, wherein the action portion of the moveable base includes at least one rib connected to the wall surface of the moveable base and a space formed between the rib and the wall surface for allowing the holding of the rib to rotate the movable base.

14. The assembly as claimed in claim 12, wherein at least one tool slot is arranged at a surface on one end of the rib.
